(19) United States
(12) Patent Application Publication
(10) Pub. No.: US 2013/0179618 A1
(43) Pub. Date: Jul. 11, 2013

(54) Dynamic Resource Management in Mobile Computing Devices

(71) Applicants: Juan M. Casas, JR., Round Rock, TX (US); Nikhil Hegde, Round Rock, TX (US); Alexander Medvedev, Austin, TX (US); Rashmi Narasimhan, Round Rock, TX (US)

(72) Inventors: Juan M. Casas, JR., Round Rock, TX (US); Nikhil Hegde, Round Rock, TX (US); Alexander Medvedev, Austin, TX (US); Rashmi Narasimhan, Round Rock, TX (US)

(73) Assignee: INTERNATIONAL BUSINESS MACHINES CORPORATION, Armonk, NY (US)

(21) Appl. No.: 13/343,802

(22) Filed: Jan. 5, 2012

(51) Int. Cl. G06F 13/14

(52) U.S. Cl. 710/303

(57) ABSTRACT

Provided are techniques for physically coupling, via a docking port, a first stand-alone computing device to a communication bus coupled to a set of processing resources; detecting, by the communication bus, the coupling; responsive to the detecting of the coupling, correlating the stand-alone computing device to a subset of the set of processing resources; signaling, by the communication bus, each resource of the subset of the coupling; and responsive to the signaling, dynamically configuring the stand-alone computing device and each resource of the subset to enable the stand-alone computing device to utilize each resource of the subset.

### FIELD OF DISCLOSURE

The claimed subject matter relates generally to computing and, more specifically, to techniques for augmenting processing power and memory of mobile computing devices.

### SUMMARY

Provided are techniques for augmenting processing power and memory of mobile computing devices. Hand-held device such as smart phones, app phones, tablet computers and personal digital assistants (PDAs) are becoming increasingly popular. Wide-spread adoption of such devices has fueled a demand for higher computing capacity and memory in these devices. In addition, mobile and hand-held devices are becoming a necessity rather than a luxury, which also increases the demand for increased computing resources. In current hand-held and other mobile devices, the amount of available resources may depend upon battery life and thermal tolerance.

Disclosed techniques include techniques for physically coupling, via a docking port, a first stand-alone computing device to a communication bus coupled to a set of processing resources; detecting, by the communication bus, the coupling; responsive to the detecting of the coupling, correlating the stand-alone computing device to a subset of the set of processing resources; signaling, by the communication bus, each resource of the subset of the coupling; and responsive to the signaling, dynamically configuring the stand-alone computing device and each resource of the subset to enable the stand-alone computing device to utilize each resource of the subset.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is a block diagram of a one example of a computing system architecture that may implement the claimed subject matter.

FIG. 2 is a block diagram of a docking station, first introduced in FIG. 1, in greater detail.

FIG. 3 is a flowchart of a Setup Docking Station process that implements aspects of the claimed subject matter.

FIG. 4 is a flowchart of an Operate Docking Station process that may implement aspects of the claim subject matter.

FIG. 5 is a flowchart of a Dock Device process that may implement aspects of the claimed subject matter.

FIG. 6 is a flowchart of an Undock Device process that may implement aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As the use of hand-held communication devices has increased, the demand for additional computing resources related to these communication devices has also increased. Currently, additional resources are limited by such factors as battery life and thermal tolerance. In the example of a person with a smart phone and a laptop, both devices may perform some functions in common but a smart phone may not have enough processing power or memory to handle larger tasks. If the smart phone possessed additional computing power and memory, the smart phone could accomplish tasks that would otherwise need to be executed on a laptop or desktop computer. Current systems that enable a portable device to be plugged into peripheral devices typically only enable the portable device to use monitors, keyboards, pointing devices and video, USB and other communication ports.

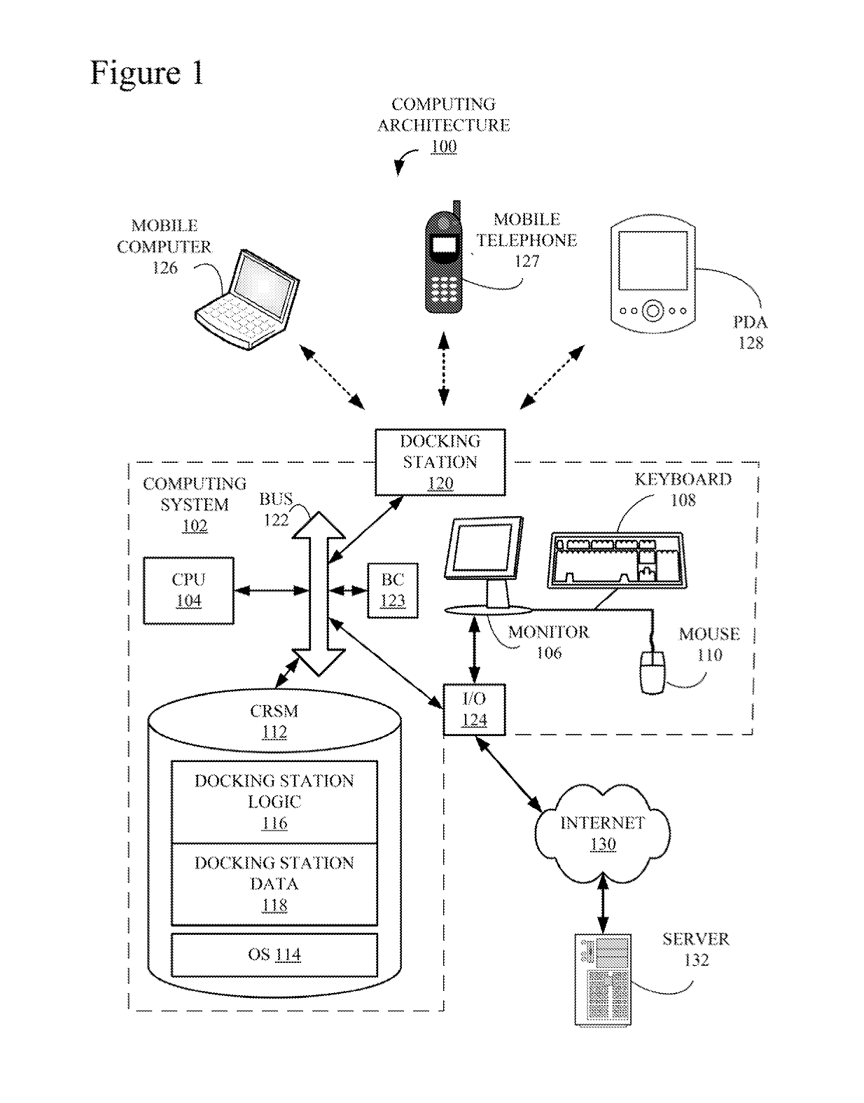

Turning now to the figures, FIG. 1 is a block diagram of a computing architecture 100 that incorporates the claimed subject matter. A computing system 102 includes a central processing unit (CPU) 104, which includes one or more processors (not shown), a display device, or monitor, 106, a keyboard 108 and a pointing device, or “mouse,” 110. Monitor 106, keyboard 108 and mouse 110 facilitate human interaction with computing architecture 100 and computing system 102.

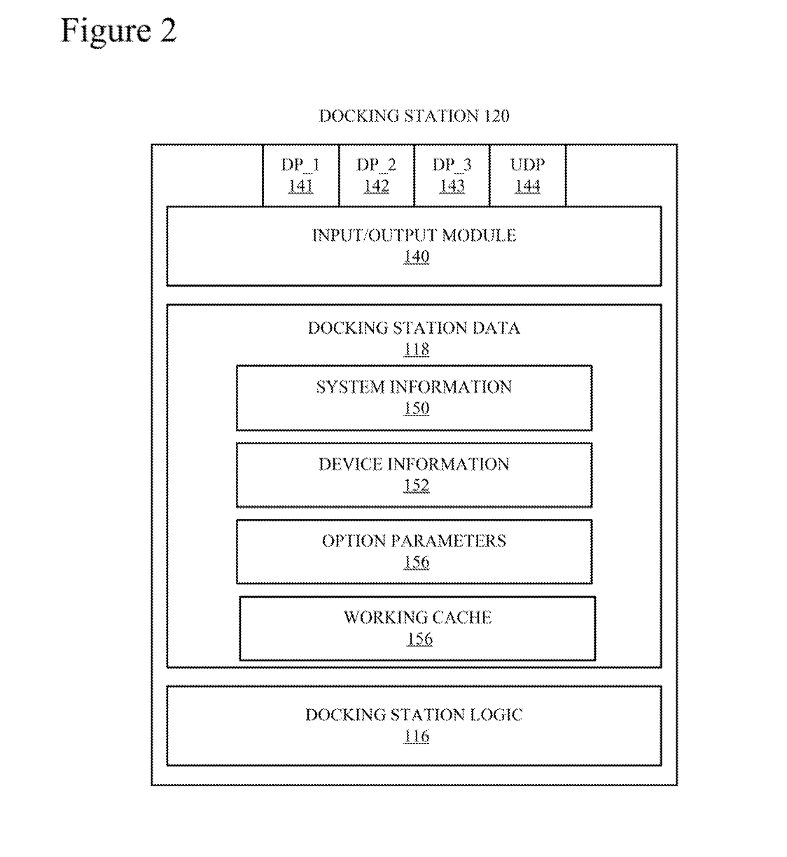

Coupled to computing system 102 and attached to CPU 104 is a computer-readable storage medium (CRSM) 112, which may either be incorporated into client system 102 i.e. an internal device, or attached externally to CPU 104 by means of various, commonly available connection devices such as but not limited to, a universal serial bus (USB) port (not shown). CRSM 112 is shown storing an operating system (OS) 114, which may be any available operating system and will be familiar to those with skill in the relevant arts. Also stored on CRSM 112 are docking station logic 116 and docking station data 118, which are described in more detail below in conjunction with FIGS. 2-6.

Also coupled to computing system 102 is a docking station 120. Docking station 120, CPU 104, CRSM 112 and an input/output (I/O) module 124 communicate over a communication bus 122 that is controlled by a bus controller (BC) 123. Docking station 120 provides connectivity for a mobile computer 126, a mobile telephone 127 and a personal digital assistant (PDA) 128 in accordance with the claimed subject matter. Devices 126, 127 and 128 are used as examples of some types of communication and computing devices that may take advantage of the disclosed technology. Other examples include, but are not limited to, laptop computers, notebook computers, netbook computers, tablet computers and other types of communication and computing devices. Docking station 120 is described in more detail in conjunction with FIGS. 2-6.

Computing system 102 is connected to the Internet 130 via input/output module 124. Also coupled to the Internet 130 is a server computer 132. Although in this example, computing system system 102 and server 132 are communicatively coupled via the Internet 130, they could also be coupled through any number of communication mediums such as, but not limited to, a local area network (LAN) (not shown). It should be noted there are many possible computing system configurations that may incorporate the disclosed technology, of which computing architecture 100 and computing system 102 are only simple examples.

FIG. 2 is a block diagram of docking station 120, first introduced in FIG. 1, in greater detail. Docking station 120 includes an input/output (I/O) module 140, docking station data 118 (FIG. 1) and docking station logic 116 (FIG. 1), which is executable code for controlling the operation of docking station 120. For the sake of the following examples, docking station logic 116 is assumed to execute on computer system 102 (FIG. 1) and to be stored on CRSM 112 (FIG. 1). It should be understood that the claimed subject matter can be implemented in many types of computing systems and data storage structures but, for the sake of simplicity, is described only in terms of computing system 102 and system architecture 100 (FIG. 1). Further, the representation of docking station 120 in FIG. 2 is a logical model. In other words, components 116, 118 and 140 may be stored in the same or separates files and loaded and/or executed within computing system 102 either as a single system or as separate processes interacting via any available inter process communication (IPC) techniques.

I/O module 140 handles any communication docking station 120 has with other components of computing system 102 and architecture 100. Coupled to I/O module 140 are four (4) communication ports, i.e. a docking port_1, or “DP_1,” 141, a docking port_2, or “DP_2,” 142, a docking port_3, or “DP_3,” 143 and a universal docking port, or “UDP,” 144. Docking ports 141-143 are employed by specific devices, which in this example are mobile computer 126, mobile telephone 127 and PDA 128, respectively. In this example, UDP 144 is a universal connection device such as, but not limited to a universal serial bus (USB) connection that may accommodate multiple devices that include an appropriate connector.

Docking station data 118 is a data repository for information, including settings and parameters, that docking station 120 requires during normal operation. Examples of the types of information stored in docking station data 118 include system information 150, device information 152, option parameters 156 and a working cache 156. System information 152 stores information about computing system 102 that is necessary for docking station 120 to implement the disclosed functionality. Examples of system configuration information include, but are not limited to, the number and type of processors and number and type of memory devices.

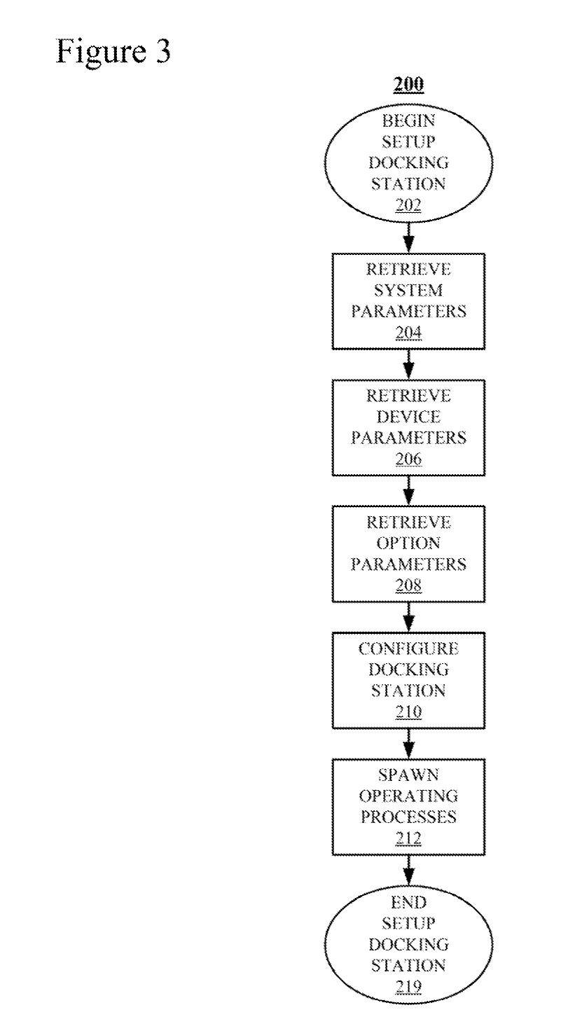

Device information 152 stores information, including configuration options for devices that may employ docking station in accordance with the claimed subject matter. Some examples include, but are not limited to, mobile computer 126 (FIG. 1), mobile telephone 127 (FIG. 1) and PDA 128 (FIG. 1). Option parameters 154 stores information relating to user configurable options for controlling docking station 120. Examples of user configurable information include, but are not limited to, timeout parameters and user notification options. Working cache 156 is employed by docking station 120 to store the intermediate results of running processes. The elements of data cache 118 and docking station 120 are explained in more detail below in conjunction with the examples described in FIGS. 3-6.

FIG. 3 is a flowchart of a Setup Docking Station process 200 that implements aspects of the claimed subject matter. In this example, logic associated with process 200 is stored on CRSM 112 (FIG. 1) and executed on one or more processors (not shown) of CPU 104 of computing system 102.

Process 200 starts in a “Begin Setup Docking Station” block 202 and proceeds immediately to a “Retrieve System Parameters” block 204. During processing associated with block 204, parameters associated with the configuration of computing architecture 100 are retrieved from system information 150 (FIG. 2) of docking station data 118 (FIGS. 1 and 2). During processing associated with a “Retrieve Device Parameters” block 206, parameters corresponding to devices that may utilize docking station 120 are retrieved from device information 152 (FIG. 2) of docking station data 118. Examples of such devices include, but are not limited to, mobile computer 126 (FIG. 1), mobile telephone 127 (FIG. 1), PDA 128 (FIG. 1) and a tablet computer (not shown).

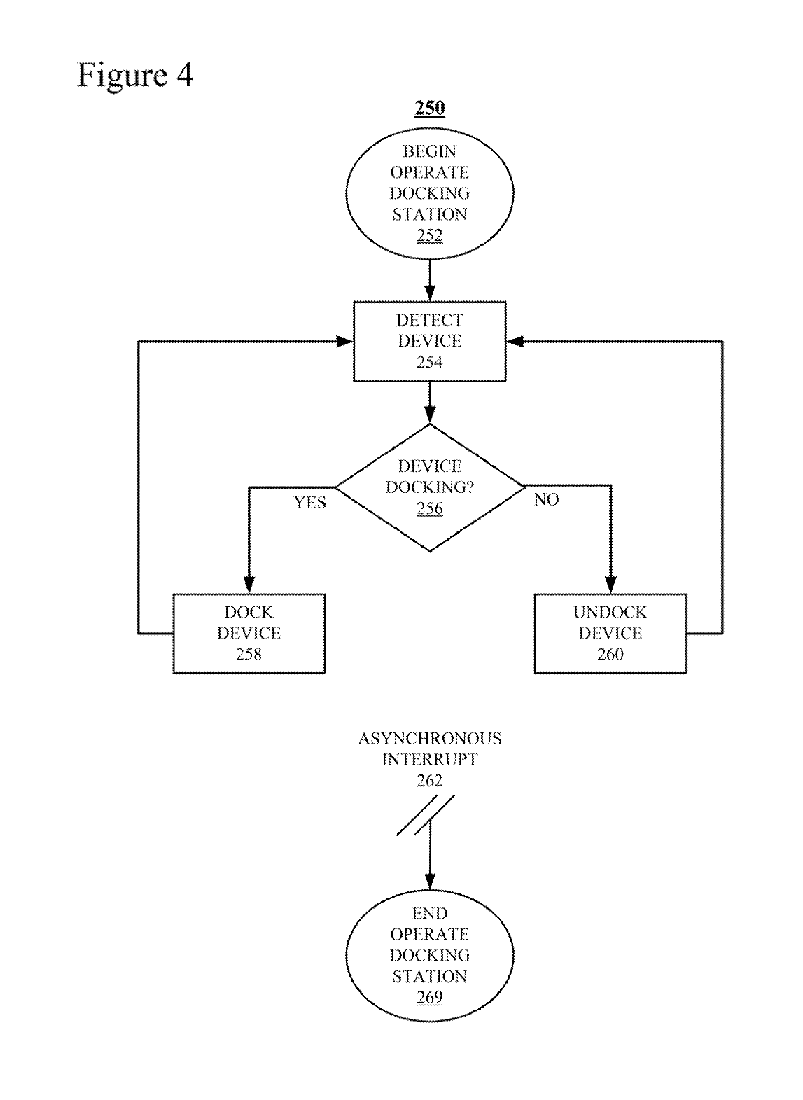

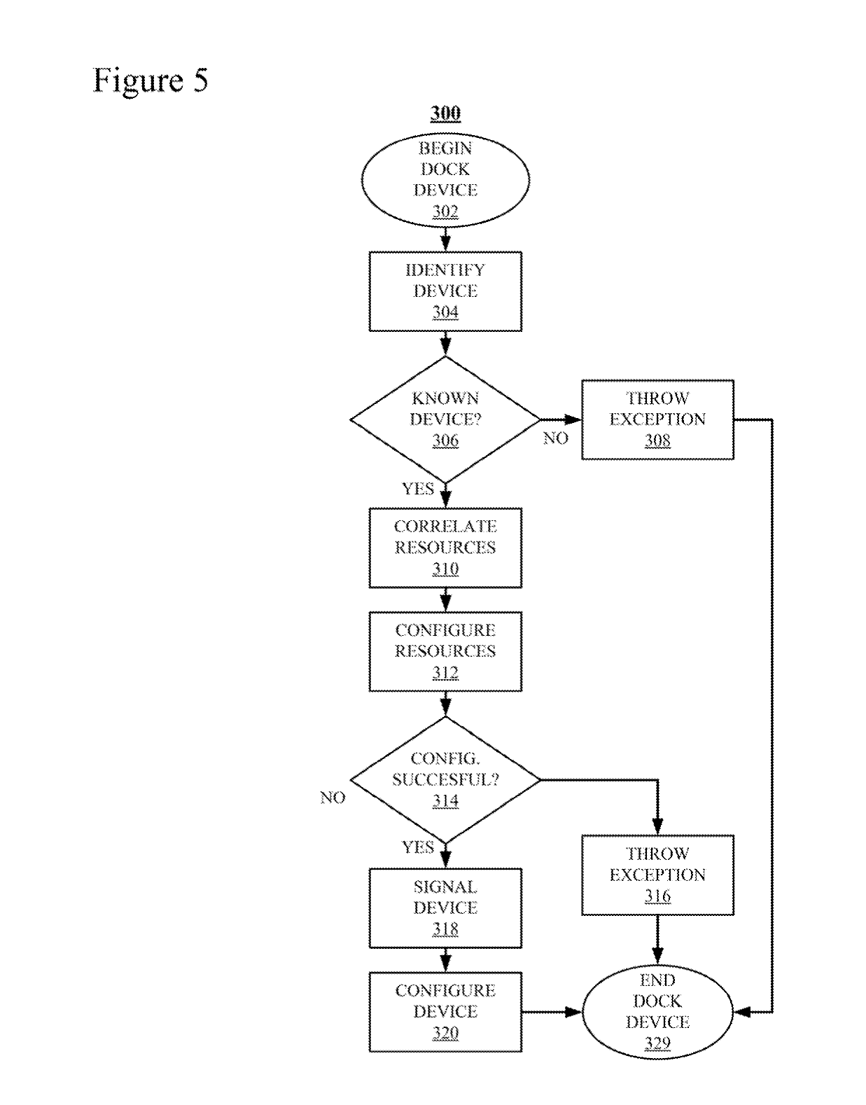

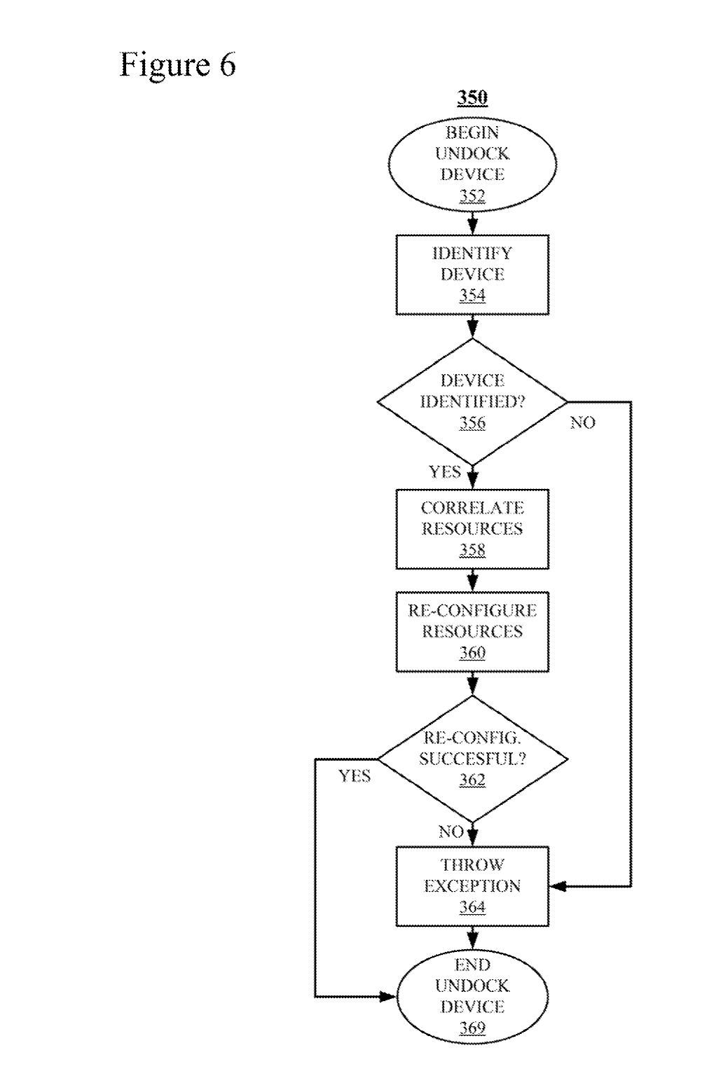

During processing associated with a “Retrieve Option Parameters” block 208, information relating to the configuration of docking station 120 is retrieved from Options parameters 156 (FIG. 2) of docking station data 118. During processing associated with a “Configure Docking Station” block 210, docking station is setup for normal operation using the parameters retrieved during processing associated with blocks 204, 206 and 208. Configuration of docking station 120 includes the configuration of docking ports 141-144 (FIG. 2). During processing associated with a “Spawn Operating Processes” block 212, a process is spawned to execute the normal operation of docking station 120 (see 250, FIG. 4; 300, FIG. 5 and 350, FIG. 6). Finally, control proceeds to an “End Setup Docking Station” block 219 during which process 200 is complete.

FIG. 4 is a flowchart of an Operate Docking Station process 250 that implements aspects of the claimed subject matter. Like process 200 (FIG. 3), in this example, logic associated with process 250 is stored on CRSM 112 (FIG. 1) and executed on one or more processors (not shown) of CPU 104 of computing system 102. Process 250 is initiated during processing associated with block 212 (FIG. 3) of Setup Docking station process 200 (FIG. 3).

Process 250 starts in a “Begin Operate Docking Station” block 252 and proceeds immediately to a “Detect Device” block 254. During processing associated with block 254, docking station 120 waits for a device such as mobile computer 126 (FIG. 1), mobile telephone 127 (FIG. 1), PDA 128 (FIG. 1) or a tablet computer (not shown) to be either coupled to or uncoupled from docking station 120, i.e. a change of status is detected on one of docking ports 141-144 (FIG. 2). During processing associated with a “Device Docking?” block 256, a determination is made as to whether or not the status change detected during processing associated with block 254 represents that a device has been coupled to docking station 120. If so, control proceeds to a “Dock Device” block 258. Processing associated with block 258 is explained in more detail below in conjunction with a Dock Device process 300 of FIG. 5.

If during processing associated with block 256, a determination is made that the status change detected during processing associated with block 254 does not represent the coupling of a device to docking station 120, i.e. the change represents a device uncoupling from docking station 120, control proceeds to an “Undock Device” block 260. Processing associated with block 260 is described below in conjunction with process 350 of FIG. 6. Following processing associated with blocks 258 and 260, process 250 returns to Detect Device block 254 and awaits the next change of status with respect to docking ports 141-144 and processing continues as described above.

Typically process 250 loops continuously through blocks 254, 256, 258 and 260 processing status changes detected on docking ports 141-144. In the event computing system 102 is halted or an administrator chooses to halt process 250 an asynchronous interrupt 262 is generated. Asynchronous interrupt 262 initiates a change of control to an “End Operate Docking Station” block 269 in which process 250 is complete.

FIG. 5 is a flowchart of a Dock Device process 300 that implements aspects of the claimed subject matter. In this example, logic associated with process 300 is primarily stored on CRSM 112 (FIG. 1) and executed on one or more processors (not shown) of CPU 104 of computing system 102. Portions of process 300 may be stored and executed on devices such as devices 126-128 (FIG. 1) that utilize docking station 120. As explained above in conjunction with FIG. 4, process 300 is executed in response to the detection of a status change on one of docking ports 141-144 (FIG. 2) (see 254, FIG. 4) and a determination the status change represents a device such as mobile computer 126 (FIG. 1), mobile telephone 127 (FIG. 1), PDA 128 (FIG. 1) or a tablet computer (not shown) coupling to one of docking ports 141-144.

Process 300 starts in a “Begin Dock Device” block 302 and proceeds immediately to an “Identify Device” block 304. During processing associated with block 304, the device that triggered the status change is identified, if possible. The identification may be implemented using data from device information 152 (FIG. 2) of docking station data 118 (FIGS. 1 and 2). During processing associated with a “Known Device?” block 306, a determination is made as to whether or not the device that triggered the status change was able to be identified during processing associated with block 304. If not, control proceeds to a “Throw Exception” block 308 during which appropriate measures are taken to address the inability of docking station 120 to accommodate the current docking attempt. Such measures may include, but are not limited to, notifying an administrator, logging the attempt and/or transmitting a failure signal to the device that has attempted to dock.

If a determination is made during processing associated with block 306 that that device attempting to dock is a known device, control proceeds to a “Correlate Resources” block 310. During processing associated with block 310, the resources of computing system 102 that are configured for operation with the docking device are identified. This determination is based upon both device information 152 and option parameters 156 (FIG. 2), both of docking station data 118.

During processing associated with a “Configure Resources” block 312, the resources identified during processing associated with block 310 are reconfigured to augment the resources of the docking device. A signal is transmitted from docking station 120 to bus 122 (FIG. 1), under the control of BC 123 (FIG. 1), to initiate the configuration of the resources identified during processing associated with block 310. BC 123 and bus 122 then signal the identified resources, or components, which may include, but are not limited to, CPU 104, monitor 106, keyboard 108, mouse 110, CRSM 112 and IO 124. During processing associated with a “Configuration (Config.) Successful?” block 314, a determination is made as to whether or not the configuration of resource initiated during processing associated with block 312 was successful. This determination is made based upon acknowledgements to BC 123 and bus 122 from the various identified components. It should be noted that some components may acknowledge success and some components may either acknowledge a configuration failure or fail to respond.

In the event of a complete lack of configuration success, i.e. no component signals success, control proceeds to a “Throw Exception” block 316. During processing associated with block 316, bus 122 and BC 123 signal docking station 120 and docking station 120 takes appropriate action, including but not limited to, action such as notifying an administrator, logging the attempt and/or transmitting a failure signal to the device that has attempted to dock.

In the event that the a determination is made during processing associated with block 314 that the configuration initiated during processing associated with block 312 was a least partially successful, control proceeds to a “Signal Device” block 318. During processing associated with block 318, the device that was identified during processing associated with block 304 is notified, via bus 122, of the components that have become available, i.e. transmitted an indication of successful configuration during processing associated with block 314. During processing associated with a “Configure Device” block 320, the device identified during processing associated with block 304, reconfigures to utilize the available components.

Finally, once the device has been configured during processing associated with block 320, and confirmation of the reconfiguration has been received by bus 122 and BC 123, of an exception has been thrown during processing associated with either block 308 or block 316, control proceeds to an “End Dock Device” block 329 during which process 300 is complete.

FIG. 6 is a flowchart of an Undock Device process 350 that implements aspects of the claimed subject matter. Like process 300, in this example, logic associated with process 350 is primarily stored on CRSM 112 (FIG. 1) and executed on one or more processors (not shown) of CPU 104 of computing system 102. Portions of process 350 may be stored and executed on devices such as devices 126-128 (FIG. 1) that utilize docking station 120. As explained above in conjunction with FIG. 4, process 250 is executed in response to the detection of a status change on one of docking ports 141-144 (FIG. 2) (see 254, FIG. 4) and a determination the status change represents a device such as mobile computer 126 (FIG. 1), mobile telephone 127 (FIG. 1), PDA 128 (FIG. 1) or a tablet computer (not shown) uncoupling from one of docking ports 141-144.

Process 350 starts in a “Begin Undock Station” block 352 and proceeds immediately to an “Identify Device” block 354. During processing associated with block 354, the device that triggered the status change is identified if possible. The identification is implemented using data from device information 152 (FIG. 2) of docking station data 118 (FIGS. 1 and 2). During processing associated with a “Device Identified?” block 356, a determination is made as to whether or not the device that triggered the status change was able to be identified during processing associated with block 354. If not, control proceeds to a “Throw Exception” block 364 during which appropriate measures are taken to address the inability of docking station 120 to identify the undocking device. Such measures may include, but are not limited to, notifying an administrator and/or logging the attempt.

If a determination is made during processing associated with block 356 that that device attempting to dock is a known device, control proceeds to a “Correlate Resources” block 358. During processing associated with block 358, the resources of computing system 102 that have been configured for operation with the docking device (see 312, FIG. 5) are identified. This determination is based upon both device information 152, option parameters 156 (FIG. 2) and information in working cache 156 of docking station data 118.

During processing associated with a “Re-Configure Resources” block 360, the resources identified during processing associated with block 358 are reconfigured to account for the undocking of the device identified during processing associated with block 354. A signal is transmitted from docking station 120 to bus 122 (FIG. 1), under the control of BC 123 (FIG. 1), to initiated the re-configuration of the resources identified during processing associated with block 358. BC 123 and bus 122 then signal the identified resources, or components, which may include, but are not limited to, CPU 104, monitor 106, keyboard 108, mouse 110, CRSM 112 and IO 124. During processing associated with a “Re-Configuration (Re-Config.) Successful?” block 362, a determination is made as to whether or not the re-configuration of resources initiated during processing associated with block 312 was successful. This determination is made based upon acknowledgements to BC 123 and bus 122 from the various identified components. It should be noted that some components may acknowledge success and some components may either acknowledge a configuration failure or fail to respond. In the event that any of the components either signal a re-configuration failure or fail to respond, control proceeds to “Throw Exception” block 364. During block 364, appropriate measures are taken to address the inability of any components to re-configure. Such measures may include, but are not limited to, notifying an administrator and/or logging the attempt.

Finally, if a determination is made during block 362 that the re-configuration of all components was successful, or, once an exception has been processed during processing associated with block 364, control proceeds to an “End Undock Device” block 369 during which process 350 is complete.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1-5. (canceled)

6. An apparatus, comprising:
a processor;
a computer-readable storage medium;
a set of computing resources;
a communication bus coupled to the set of computing resources;
a docking port coupled to the communication bus; and
logic, stored on the computer-readable storage medium and executed by the processor, for:
detecting, by the communication bus, a coupling of a stand-alone computing device to the docking port;
responsive to the detecting of the coupling, correlating the stand-alone computing device to a subset of the set of processing resources;
signaling, by the communication bus, each resource of the subset of the coupling; and
responsive to the signaling, dynamically configuring each resource of the subset to enable the stand-alone computing device to utilize each resource of the subset.

7. The apparatus of claim 6, wherein the set of computing resources comprises a processor.

8. The apparatus of claim 6, wherein the set of computing resources comprises a computer-readable storage medium.

9. The apparatus of claim 6, the logic further comprising logic for:
detecting, by the communication bus, an uncoupling of the stand-alone computing device from the docking port;
responsive to detecting the un-coupling, signaling, by the communication bus, each resource of the subset of the un-coupling; and
responsive to the signaling corresponding to detecting of the un-coupling, re-configuring each device of the subset in accordance with the uncoupling.

10. The apparatus of claim 6, farther comprising logic, stored and executed on the stand-alone computing device, for
detecting, by the stand-alone computing device, an uncoupling of the stand-alone computing device from the docking port; and
responsive to detecting the un-coupling, dynamically re-configuring the stand-alone computing device such that the stand-alone computing device operates independently of each device of the subset.

11. A computer programming product, comprising:
a computer-readable storage medium; and
logic, stored on the computer-readable storage medium for execution by a processor, for:
detecting, by a communication bus, a coupling of a stand-alone computing device to a docking port;
responsive to the detecting of the coupling, correlating the stand-alone computing device to a set of processing resources;
signaling, by the communication bus, each resource of the set of the coupling; and
responsive to the signaling, dynamically configuring each resource of the set to enable the stand-alone computing device to utilize each resource of the set.

12. The computer programming product of claim 11, wherein the set of computing resources comprises a processor.

13. The computer programming product of claim 11, wherein the set of computing resources comprises the computer-readable storage medium.

14. The computer programming product of claim 11, the logic further comprising logic for:
detecting, by the communication bus, an uncoupling of the stand-alone computing device from the docking port;
responsive to detecting the un-coupling, signaling, by the communication bus, each resource of the subset of the un-coupling; and
responsive to the signaling corresponding to detecting of the un-coupling, re-configuring each device of the subset in accordance with the uncoupling.

15. The computer programming product of claim 11, further comprising logic, stored and executed on the stand-alone computing device, for:
detecting, by the stand-alone computing device, an uncoupling of the stand-alone computing device from the docking port; and
responsive to detecting the un-coupling, dynamically re-configuring the stand-alone computing device such that the stand-alone computing device operates independently of each device of the subset.

16. A docking port, comprising:
a communication bus coupled to a set of computing resources; and
logic, stored on a computer-readable storage medium and executed by a processor, for:
detecting, by the communication bus, a coupling of a stand-alone computing device to the docking port;
responsive to the detecting of the coupling, correlating the stand-alone computing device to a subset of the set of processing resources;
signaling, by the communication bus, each resource of the subset of the coupling; and
responsive to the signaling, dynamically configuring each resource of the subset to enable the stand-alone computing device to utilize each resource of the subset.

17. The docking port of claim 16, wherein the set of computing resources comprises a processor.

18. The docking port of claim 16, wherein the set of computing resources comprises the computer-readable storage media.

19. The docking port of claim 16, the logic further comprising logic for:
detecting, by the communication bus, an uncoupling of the stand-alone computing device from the docking port;
responsive to detecting the un-coupling, signaling, by the communication bus, each resource of the subset of the un-coupling; and
responsive to the signaling corresponding to detecting of the un-coupling, re-configuring each device of the subset in accordance with the uncoupling.

20. A computing system, comprising;
a processor;
a computer-readable storage medium;
a set of computing resources;
a communication bus coupled to the set of computing resources;
a docking port coupled to the communication bus; and
logic, stored on the computer-readable storage medium and executed by the processor, for:
detecting, by the communication bus, a coupling of a stand-alone computing device to the docking port;
responsive to the detecting of the coupling, correlating the stand-alone computing device to a subset of the set of processing resources;
signaling, by the communication bus, each resource of the subset of the coupling; and
responsive to the signaling, dynamically configuring each resource of the subset, to enable the stand-alone computing device to utilize each resource of the subset.

21. The computing system of claim 20, wherein the set of computing resources comprises a processor.

22. The computing of claim 20, wherein the set of computing resources comprises a computer-readable storage medium.

23. The computing system of claim 20, the logic further comprising logic for:
detecting, by the communication bus, an uncoupling of the stand-alone computing device from the docking port;
responsive to detecting the un-coupling, signaling, by the communication bus, each resource of the subset of the up-coupling; and
responsive to the signaling corresponding to detecting of the un-coupling, re-configuring each device of the subset in accordance with the uncoupling.

24. The computing system of claim 20, further comprising logic, stored and executed on the stand-alone computing device, for:
detecting, by the stand-alone computing device, an uncoupling of the stand-alone computing device from the docking port; and
responsive to detecting the un-coupling, dynamically re-configuring the stand-alone computing device such that the stand-alone computing device operates independently of each device of the subset.
